(19) United States
(12) Patent Application Publication
(10) Pub. No.: US 2016/0205915 A1
(43) Pub. Date: Jul. 21, 2016

(54) Bioinspired Insect Traps

(71) Applicant: UNIVERSITY OF FLORIDA RESEARCH FOUNDATION, INC., Gainesville, FL (US)

(72) Inventors: Yung-Chieh Hung, Gainesville, FL (US); Rui Qing, Gainesville, FL (US); Wolfgang M. Sigmund, Gainesville, FL (US); Benjamin A. Hottel, Gainesville, FL (US); Philip G. Koehler, Gainesville, FL (US)

(21) Appl. No.: 14/911,370

(22) PCT Filed: Sep. 29, 2014
(86) PCT No.: PCT/US14/58025

§ 371 Date: Feb. 10, 2016

Related U.S. Application Data
(60) Provisional application No. 61/883,490, filed on Sep. 27, 2013.

(51) Int. Cl. A01M 1/10

(52) U.S. Cl. CPC A01M 1/103

(57) ABSTRACT

An insect trap that is effective for Cimex I. comprises an area of rigid pillars and/or hooks where these features extend from a base. The density of the features can vary from being sufficient to inhibit the trajectory of an insect through the features or to reside and travel on the top of the features. The features can be of a thickness of less than or about that of the insect's legs and the height of the features is at least the height of the insect. The features can be of a height of about the cross-section of an insect's leg. The features can be of a thickness of four microns or less and provide a plastron surface such that the surface can be employed in conjunction with a holding chamber and oriented where a portion of the surface is vertical or inverted such that the insect's foot-tip cannot adhere to or be supported by the surface.

### CROSS-REFERENCE TO RELATED APPLICATION

The present application claims the benefit of U.S. Provisional Application Ser. No. 61/883,490, filed Sep. 27, 2013, which is hereby incorporated by reference herein in its entirety, including any figures, tables, or drawings.

### BACKGROUND OF INVENTION

Cimicidae, Cimex I, better known as bedbugs, are small parasites that prefer human blood and commonly infest the area near and of the bed. Bedbugs are typically found in mattresses, box springs, and the carpets and baseboards of a bedroom. Bedbugs tend to reside within cracks and harborages within 1.5 m of the target's bed. Because treatments must be carried out in the sleeping areas, chemical pesticides are often avoided.

Bedbugs have become increasingly more resistant to insecticides, particularly pyrethroid insecticides, which are used in the majority of bedbug's cases. The well-established resistance of bedbugs to DDT and pyrethroids has created a need for different and newer chemical approaches to the extermination of bedbugs.

Diatomaceous earth can be useful in conjunction with other methods of managing bedbug infestation, but only in a dry environment, as the dust-like material disrupts the insect's waxy outer layer of their exoskeletons causing dehydration. Boric acid is ineffectual against bedbugs because bedbugs do not groom.

Freezing or cooking bedbugs by dry ice or steam treatment of beds has inconsistent success at eradicating bedbugs. This is attributed to the protective positions within beds where they hide. Professional heat treatments, to around 45° C., kills bedbugs; however the temperature must be maintained for a significant amount of time.

The fungus Beauveria bassiana is highly effective at eliminating bedbugs exposed to the fungus spores. It is effective against bedbug colonies when spores are carried by infected bugs. Exposure to the fungus requires five days of exposure. Unfortunately, those with compromised immune systems can have very adverse reactions to the concentrated presence of the fungus following an application.

In Eastern Europe, bedbugs have been entrapped physically by bean leaves, by microscopic hooked hairs (trichomes) on the leaf surfaces. The capture mechanism is the physical impaling of bedbug feet (tarsi) by these trichomes. The mechanism is a piercing entanglement, where bedbugs are impaled by trichomes on several legs and are unable to free themselves. Only mechanically vulnerable sites on the bug tarsi are pierced by the trichomes, which are located at effective heights and orientations for this impaling. Szyndler et al. J. R. Soc. Interface, 2013, 10, 83, 20130174 examined bean leaf templated micro-fabricated surfaces including the trichomes of polymeric materials with properties chosen to mimic the plant's cell walls. Although the synthetic surfaces snagged bedbugs temporarily, they did not hinder the bug's locomotion effectively. Hence, there remains a need for an effective method of dealing with bedbugs in a safe and effective manner.

### BRIEF DESCRIPTION OF DRAWINGS

FIG. 1 shows a photograph of a hungry Cimex I.

FIG. 2 shows a photograph of a well fed Cimex I.

FIG. 3 shows a photograph of (3A) tibia and (3B) tarsi parts of Cimex I.'s legs.

FIG. 4 shows a photograph of a trap having pillar features, according to an embodiment of the invention.

FIG. 5 shows a photograph of a trap having hook features, according to an embodiment of the invention.

FIG. 6 shows a photograph of a trap having random microfibers, according to an embodiment of the invention.

FIG. 7 shows a photograph of a trap having aligned microfibers, according to an embodiment of the invention.

FIG. 8 shows SEM images of commercial membranes that have been examined as molds for the surfaces of the articles, according to embodiments of the invention, where (8A) is a track-etched polycarbonate membrane and (8B) is an anodic alumina membrane, where the size bars are 10 and 1 μm in length, respectively.

FIG. 9 is a schematic of the molding process, according to embodiments of the invention, where a polycarbonate membrane is used as the mold and removal of the mold is carried out by delamination (peeling) or dissolution of the membrane from the molded article.

FIG. 10 is SEM images of the microstructure of a surface of an uncoated PP article where the surface was molded using an anodic aluminum oxide (AAO) membrane (φ=0.2 μm), according to an embodiment of the invention, where (10A), (10B) and (10C) are different magnifications, with individual fibers clearly observable at the highest magnification.

FIG. 11 shows SEM images at two different magnifications for surfaces of uncoated PP articles, according to embodiments of the invention, where: (11A)-(11D) are articles molded using PC membranes having pore sizes of φ=3.0 μm (11A) and (11B), φ=1.2 μm (11C) and (11D); and (11E) and (11F) where the membranes were dissolved after molding with φ=6 μm.

FIG. 12 shows SEM images at two different magnifications for surfaces of uncoated polypropylene (PP) articles, according to embodiments of the invention, from articles molded using polycarbonate (PC) membranes having pore sizes of φ=3.0 μm (12A) and (12B), φ=1.2 μm (12C) and (12D), and φ=0.6 μm (12E) and (12F), where the membranes were delaminated after molding.

FIG. 13 shows SEM images at two different magnifications for surfaces of uncoated low density polyethylene (LDPE) articles, according to embodiments of the invention, from articles molded using PC membranes having pore sizes of φ=3.0 μm (13A) and (13B), φ=1.2 μm (13C) and (13D), and 0.6 μm (13E) and (13F), where the membranes were delaminated after molding.

FIG. 14 shows SEM images at two different magnifications for the surfaces of uncoated polyvinylidene fluoride (PVDF) articles, according to embodiments of the invention, from articles molded using PC membranes having pore sizes of φ=3.0 μm (14A) and (14B), φ=1.2 μm (14C) and (14D), and φ=0.6 μm (14E) and (14F) where the membranes were delaminated after molding.

### DETAILED DISCLOSURE

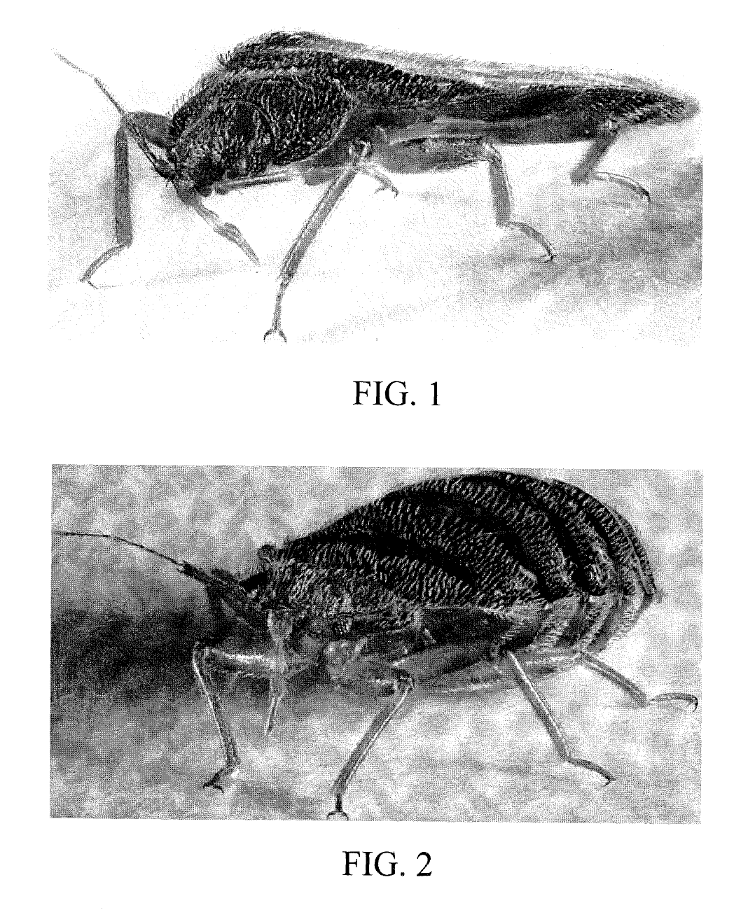

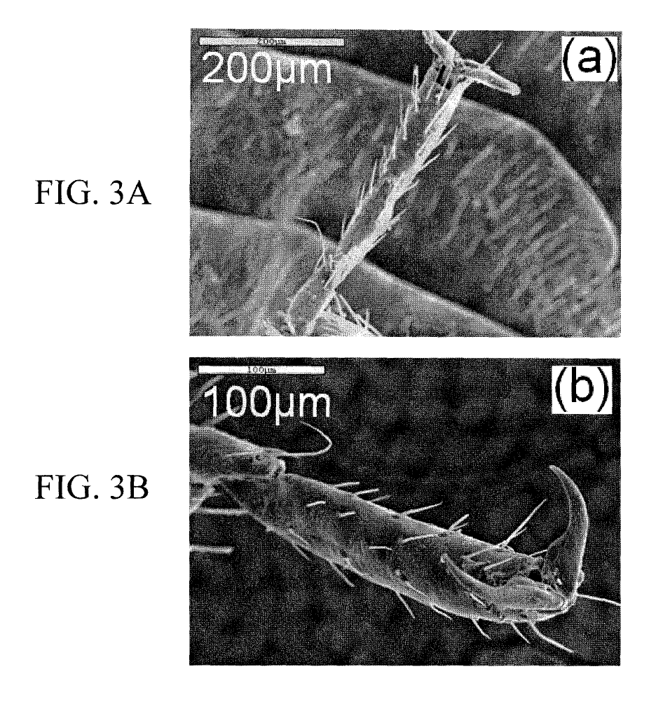

Inspired by the ability of bean leaves to trap bedbugs, embodiments of the invention are directed to improved mechanical traps that are appropriate for the structure of the Cimex I. Starving Cimex I. are flat, as shown in FIG. 1. After feasting, the abdomen of the bedbug inflates and increases the size and weight of the bedbug, as shown in FIG. 2. Note from FIGS. 1 and 2 that Cimex I. uses tarsi for locomotion, but when blood fills the abdomen additional support by the tibia of the rear legs is required, as is clear from FIG. 2. Bedbug legs are chitin covered by a layer of wax that protects against pesticide intake. Cimex I. have hair present all over the body, where the tibia and tarsi part of Cimex I.'s legs show smaller hairs, as shown in FIGS. 3A and 3B. The improved trap designs exploit the lack of bedbug's legs adhesive properties and strength of the legs to support body on tarsi when fed.

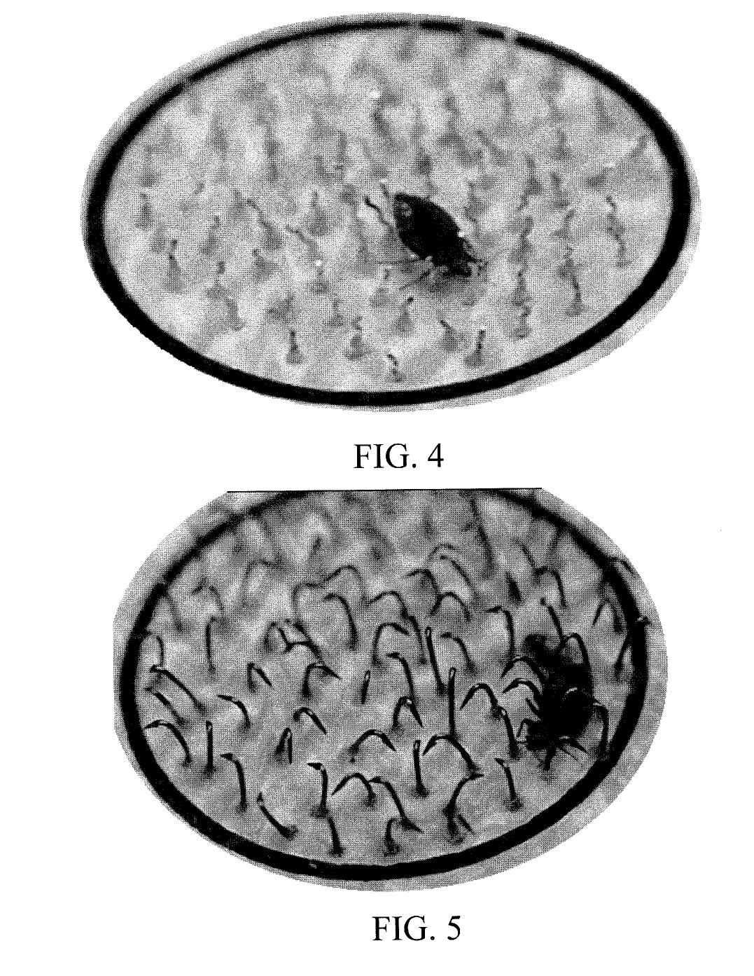

In one embodiment of the invention, vertical pillars having hook or pillar structures are supported on a base to trap the bedbug's exoskeleton, avoiding adhesive surface features. These are shown in FIGS. 4 and 5 for the pillars and hooks, respectively, These traps are constructed as a barrier. When the bedbug steps down off a short ledge to the area with the pillars and/or hooks these features inhibit the bedbug's locomotion. These features are stiff, such that they do not compress or collapse or be moved by the bedbugs. In this embodiment of the invention, the features are fibers that are sufficiently long to entrap a significant portion of the bedbugs body or the entire body. The features are of about 2 mm in height or length, although they can be slightly shorter, for example, at least 1.0 mm, at least 1.1 mm, at least 1.3 mm, at least 1.4 mm, at least 1.5 mm, at least 1.6 mm, at least 1.7 mm, at least 1.8 mm, at least 1.9 mm or at least 2.0 mm in length, and can be as long as about 5 mm or more, for example, up to 5.0 mm, 5.2 mm, 5.4, mm, 5.5 mm, or 6.0 mm. The diameter of the pillars and hooks is about 0.3 mm, for example 0.1 mm, 0.2 mm, 0.3 mm, 0.4 mm, or less, if sufficiently stiff. The length is such that upon descending to the surface, the bedbug cannot rise over the features and cannot navigate between the features, causing the bugs to be fixed. The density of the features is no smaller than 25 per cm² or the features are too sparse, permitting the entire bedbug bodies to remain between features. At 20 per cm² bedbugs are not trapped. At densities above 600 per cm², adult bedbugs can use the features as a “carpet” and no portion of the bedbug can descend between the features leading to their trapping. Intermediate densities, for example, of 30 per cm², 35 per cm², 40 per cm², 50 per cm², 60 per cm², 70 per cm², 80 per cm², 90 per cm², 100 per cm², or 150 per cm² can be used. Dense hooks can trap bedbug nymphs. This is indicated in Table 1, below, where traps of about 25 per cm² of about 2 mm lengths and about 0.3 mm diameters, or with 600 per cm², were examined. The features can be constructed of metals, ceramics, or polymers. For example, the features can be constructed of PVC, polypropylene, polyethylene, polyesters, acrylics, polystyrene, polymethacrylates, or any other polymer that can be sufficiently rigid.

TABLE 1
Trapping of Bedbugs on Traps of Various Designs and Densities.

| Area | Low Density | Dense | Dense |
|---|---|---|---|
| Density | Hooks or Pillars | Hooks | Pillars |
| Fed Male | Escape | Escape | Trapped |
| Fed Female | Escape | Escape | Trapped |
| Nymphs | Escape | Trapped | Escape |

The traps can have a mixture of features and densities, as portions of the traps can be effective for the trapping of nymphs while other portions of the traps can be effective at trapping adults. The trap can have areas of different densities distributed in any periodic, random or quasiperiodic manner. The density of features can be of a gradient over the area of the trap. In this way, the probability of either nymphs or adults to cross the entire trap is low. The traps can be constructed such that they can act as a barrier around a bed, the bedroom, near sites of entry or egress from a bedroom, such as electrical outlets or cable outlets. The traps can be as strips that can be placed on the floor, between the mattress and box spring, or in any other location where one anticipates the movement of bedbugs. The traps can be constructed with an edge barrier that when crossed obliges the bedbug to drop onto the trap and not immediately leave before experiencing all of the trap's features. The traps can be prepared by various manners, including molding, flocking, or otherwise drawing fibers up from a surface. The base of the trap can be flat, curved, or have any other terrain to direct or otherwise oblige the bedbugs to enter into the areas of pillars and/or hooks.

The traps can act as a barrier. The traps can be mounted and employed with the features oriented in any orientation, that is horizontal up, horizontal down, vertically, or at any angle. The traps can be used to deter the entry of the bedbugs to a bed or other area, as the bedbugs cannot cross the barrier. The bedbugs cannot crawl over trapped bedbugs.

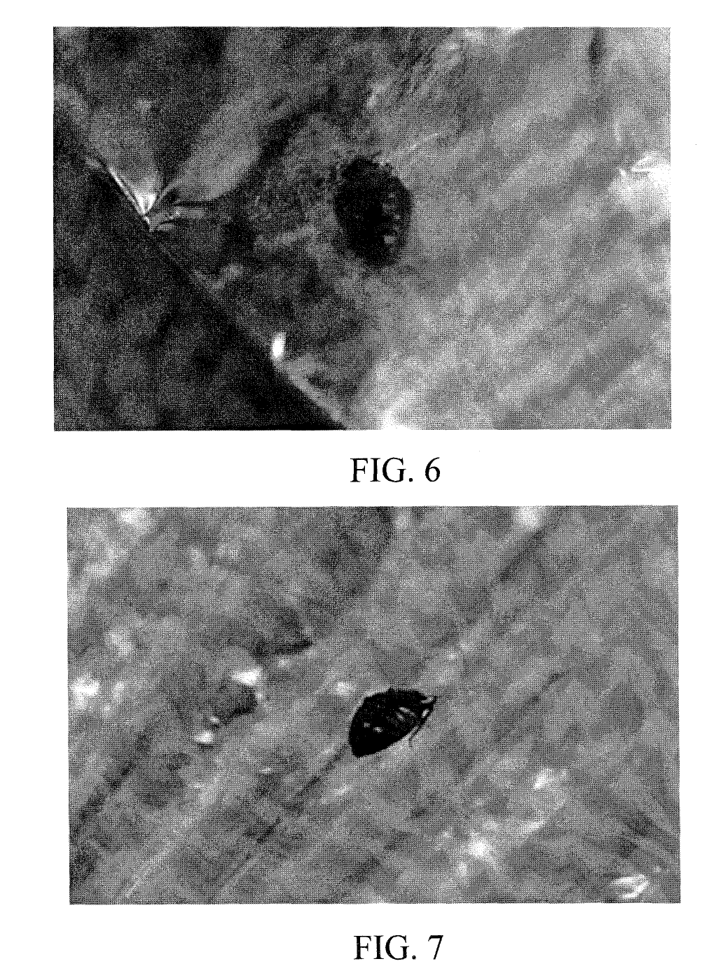

In another embodiment of the invention, microfibers that are aligned randomly or in parallel are employed to trap Cimex I. via their tibia and tarsi. The microfibers can be electro-spun fibers or made by other fiber formation techniques. This embodiment is shown in FIGS. 6 and 7 where random and aligned microfiber traps are illustrated. The random traps can be a surface resembling cotton candy, where the hairs of the bedbug's legs and the legs encircled by the microfibers or nanofibers fix the bedbug to the surface of the fibers. In aligned fibers, the weight of the bedbug aids in the separation and insertion of the tibia and tarsi between the aligned fibers which then trap the legs.

In another embodiment of the invention, the microfibers are shorter; being inspired by or molded from the surface of beggar's lice seed pods (Hackelia virginiana). In this embodiment of the invention, the legs or a small portion of the body is entrapped due to the size of the fiber features. The beggar's lice pods have a surface that has a robust hooking structure that traps bedbugs. The bedbug trap, according to an embodiment of the invention, has a surface that mimics the surface of the beggar's lice pods with hooks that are about 300 μm in length and about 30 μm in cross-section. Hence the hooks are about 200 to about 500 μm in length and about 10 to about 50 μm in cross-section. For example the hooks can be 200×10 μm to 500×10 μm in dimension, 200×50 μm to 500×50 μm such that the aspect ratio, length to cross-section, of the fibers is 4 to 10.

In one embodiment of the invention, the bedbug trap is formed by a soft-molding of the surface of beggar's lice seed pods; for example, molding a plurality of appropriately positioned pods with a silicone room temperature vulcanization (RTV) or other silicone resin or any other soft-material resin that can be placed on the textured surface consisting of a plurality of pods, cured to a resin, for example, but not necessarily, a rubber, and the pods removed or decomposed leaving a mold of the cured resin having the template pods' textured surface. A beggar's lice seed pod mimic or the ultimate molded trap can be used as the template for the cured resin mold. The cured resin mold can then be used to infuse a resin that can form a thermoset polymer, thermoplastic polymer, or a ceramic upon curing that retains the features of the beggar's lice seed pod surface. The cured resin can be that of any polymer or ceramic whose uncured resin can be infused into the soft mold without diffusing into the rubber. The resin can be a vinyl resin or a condensation cure resin. The polymeric resin can be an acrylic resin, stryrenic resin, a polyester resin, a polyamide resin, or any other resin that can be infused into the about 300×30 μm voids extending from the surface of the mold. After curing of the resin to form the bedbug trap, the mold can be delaminated from the trap or the mold can be decomposed or dissolved to release the trap.

In another embodiment of the invention, a mimic of the beggar's lice seed pod surface can be formed by spraying or otherwise distributing ceramic and/or polymer micro fibers on a surface to which they will adhere. In this embodiment, a surface with a distribution of approximately 300×30 μm at least a portion of the fibers are oriented to be non-planar with the surface to which they are applied. For example, the fibers can be applied by: flocking, such as electrostatic flocking, pneumatic flocking, or gravity flocking; spraying; or any other means of decorating a surface with fibers to achieve adhered fibers with an orientation that is not parallel to the contacting surface. A plurality of fibers of different composition can be co-applied where the properties, such as solubility or melting or decomposition temperature is significantly different such that sacrificial fibers can be removed while leaving the beggar's lice seed pod mimic from the non-sacrificial remaining fibers. For example, a mixture of ceramic and polymeric fibers can be flocked onto a pre-ceramic receiving surface which is then cured in an oven of sufficient temperature to leave a ceramic bedbug trap when the polymer has been decomposed thermally during curing.

The traps can be used on surfaces that are vertical, horizontal, or at any angle to provide the beggar's lice seed pod inspired surface to the path over which the bedbug must travel to approach a potential host's bed. Traps can be for one-time use or reusable. For example, a reusable ceramic bedbug trap can be formed where the entrapped bedbugs can be pyrolysized from the used trap to form a regenerated trap. In the case of a polymeric resin, the surface can be one that may be cleaned with an aqueous solution, such as an acid solution, base solution, or a surfactant solution by which the dead or dying bedbugs can be removed from the trap.

In another embodiment of the invention, the microfiber length is even shorter, using a plastron surface technology where the stiffness, spacing, and size of the fibers is such that the bedbug cannot achieve traction on the trap's fiber surface. The surface is positioned at a significant pitch, generally, but not necessarily, more than 45° from horizontal, and a container is maintained on the floor of the trap to collect entrapped bedbugs. In this manner, the trap having a plastron surface shields against the climbing of bedbugs on it. The surface employs features that are fibers having in cross-section, generally, but not necessarily, a diameter, of less than 4 μm, for example 0.1 to 4 μm, 0.1 to 3 μm, 0.1 to 2 μm, 0.1 to 1.5 μm, 0.1 to 1.0 μm, 0.2 to 4 μm, 0.2 to 3 μm, 0.2 to 2 μm, 0.2 to 1.5 μm, 0.2 to 1.0 μm, 0.3 to 4 0.3 to 3 μm, 0.3 to 2 μm, 0.3 to 1.5 μm, 0.3 to 1.0 μm, 0.4 to 4 μm, 0.4 to 3 μm, 0.4 to 2 μm, 0.4 to 1.5 μm, or 0.4 to 1.0 μm fibers with hairy structure spaced on it such that it is superhydrophobic, displaying as much or more of the hypothetical smooth top surface that is occupied by voids and not the fibers. The construction of such surfaces is disclosed in International Application Publication WO2012/064745, which is incorporated herein in its entirety.

According to an embodiment of the invention, the plastron surface can be situated vertically placed, reversely placed, such that the bedbug is partially inverted, or the surface can be curved such that the bedbug at some part of the path across the trap must be on a vertical or inverted surface to prevent the bedbug from being able to cross the trap without slipping into an entrapment cell, in the form of a pitfall trap. The density of the fibers can be such that the bedbug's, or other insect's, foot tip. The plastron surface that is vertical, inverted, or curved can be attached to a base that can be attached to a piece of furniture, such as a bed's legs or can be a portion of the legs or other support for a piece of furniture.

Any of the traps according to embodiments of the invention can be employed with other insect pests that are of appropriate dimensions and characteristics to be trapped in this manner. Some insects are less likely to be trapped by the pillar and hook traps, according to an embodiment of the invention, but can be trapped by the microfiber traps according to an embodiment of the invention. One of ordinary skill in the art can adjust the dimensions of a given trap to the dimensions and characteristics of the insect pest for eradication to determine the potential efficacy and specific dimensions of the trap to be considered.

### METHODS AND MATERIALS

### Commercial Porous Membrane as Plastron Surface Molds

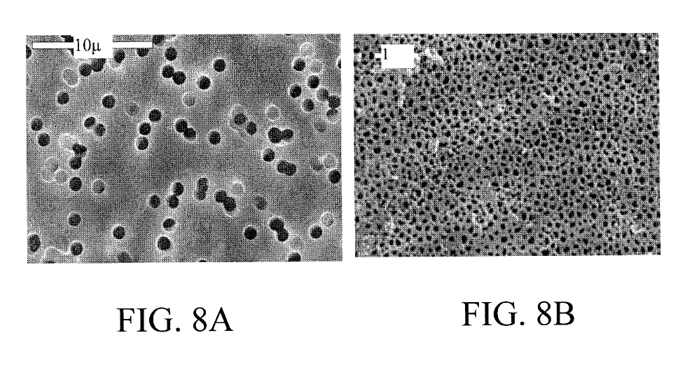

FIG. 8A shows an SEM photo of: Anodic aluminum oxide (AAO) membrane (Anopore, Whatman), pore size: 0.2 μm, and FIG. 8B shows an SEM photo of track-etched polycarbonate (PC) membrane (ISOPORE™, Millipore Inc), pore size=0.6, 1.2 and 3.0 μm

### Thermoplastic Plastron Surface Material Properties

Table 1 is a summary of thermoplastics' properties. The PS (polystyrene) and PMMA (Polymethyl methacrylate) films were prepared by drying polymer solutions in which PS and PMMA granules were dissolved (at 15 wt %) in toluene and tetrahydrofuran (THF), respectively.

TABLE 1
Thermoplastic used for base articles and re-entrant structures

| | Surface Tension (20° C.) | | |
|---|---|---|---|
| | γ_{LV} | θ_{c} | |
| Polymers | (mN/m)^{a} | (mN/m)^{b} | Sources |
| PP (Polypro- | 29.4 | 28.6 | File jacket No. 85781, |
| pylene) | | | SMEAD co. |
| PVDF (Polyvinyl- | — | 23.2 | Kynar ® sheet |
| idene fluoride) | | | Westlake Chemical Inc. |
| LDPE (Low-density | 34.3 | 32.0 | HIS-070335-G-01 |
| polyethylene) | | | Small Parts Inc. |
| PET (Polyethylene | — | 46 | PES-19900-F-01 |
| terephthalate) | | | Small Parts Inc. |
| PS (Polystyrene) | 40.7 | 41.4 | Lab prepared |
| PMMA (Polymeth- | 41.1 | 35.9 | Lab prepared |
| ylmethacrylate) | | | |

^{a}Liquid surface tensions γ_{LV} of solid polymers extrapolated from higher temperature studies of polymer melts.
^{b}Zisman critical surface tension θ_{c} obtained from contact angle measurement of a series of liquids of surface tension.

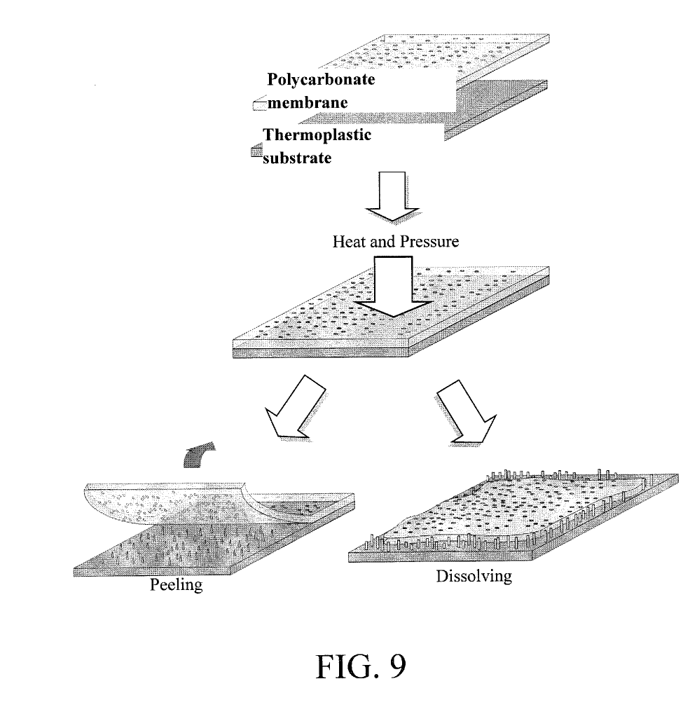

Thermoplastic sheets were cut into 1.5 cm squares and sonicated in acetone and DI water for 5 minutes. The sheet was dried in air and a membrane mold was placed on the sheet and then sandwiched between two glass slides using binder clips to hold the assembly together. The assembly was then placed in a vacuum oven (vacuum pressure<1 kPa, VO914A, Lindberg/Blue M co.) at a desired temperature for 10 minutes. Alumina membranes were removed by dissolving in 45% KOH solution for 10 minutes while PC membrane was dissolved in dichloromethane (CH₂Cl₂) for 5 minutes. The PC membrane was peeled off by hand, to delaminate the membrane from thermoplastic sheets. FIG. 9 is a schematic representation for molding and removal of the thermoplastic from the membrane mold.

Polypropylene (PP) Plastron Trap

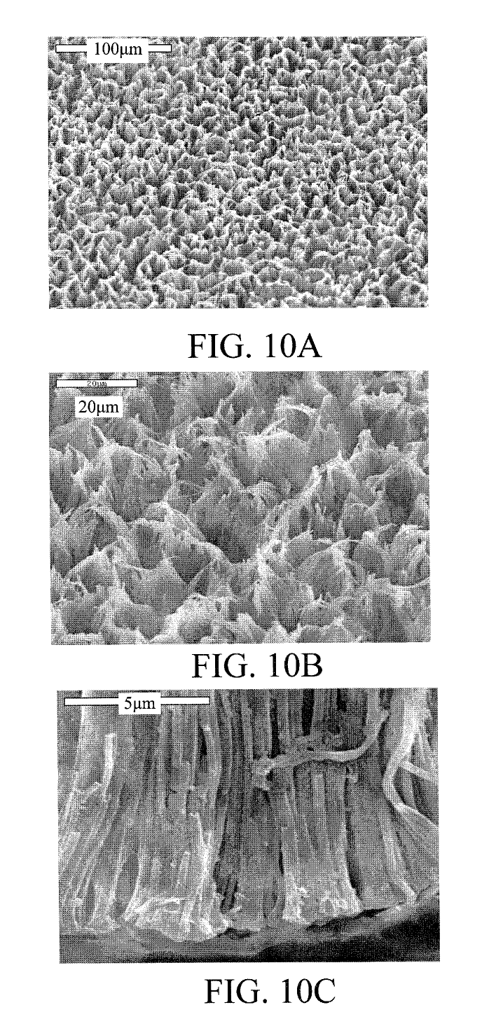

The PP used was from a general file jacket (No. 85781, SMEAD Co.), where differential scanning calorimetry (DSC) analysis determined a melting temperature of 165° C. The PP sheet from the jacket was pressed against an AAO membrane (μ=0.2 μm) at 190° C. for 10 minutes followed by dissolving the membrane in aqueous KOH. FIGS. 10A-10C shows the surface morphology after dissolving the membrane from different angles and magnification. The protruded structure formed a grass-like surface where hundreds of submicron-sized fibers clumped together and randomly curled along a vertical projection. The diameter of fibers is in good agreement with the pore size, and the high pore density of the pores in the membrane (10⁸-10⁹ cm ²), the mean distance between pores is only about 50 nm promoting the aggregation of fibers rather than fibers residing as individual entities.

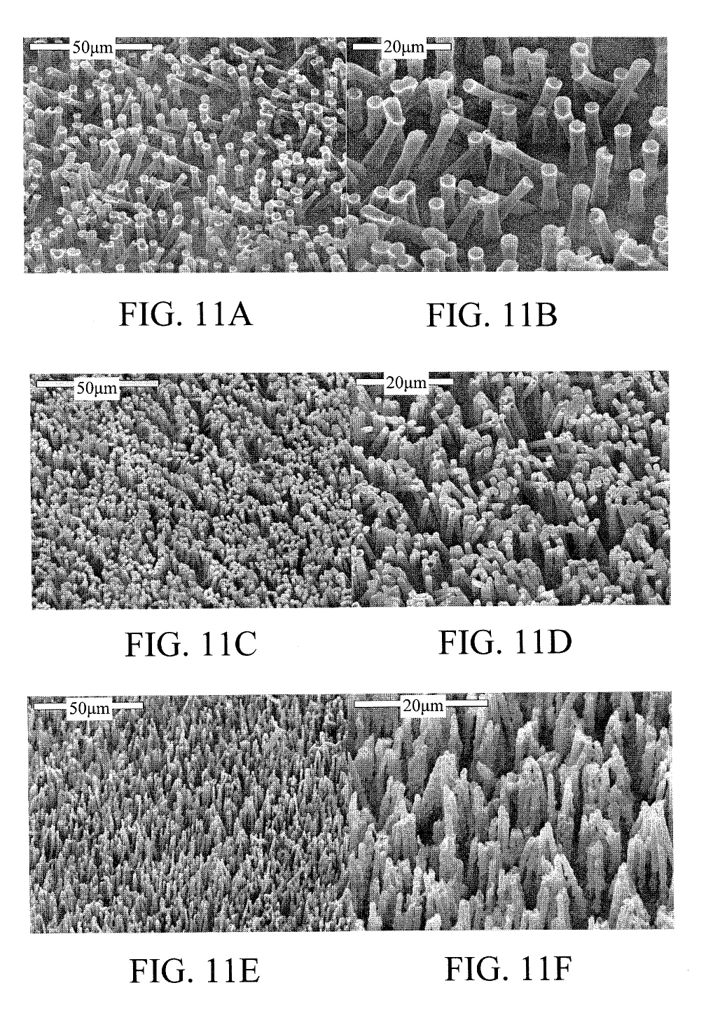

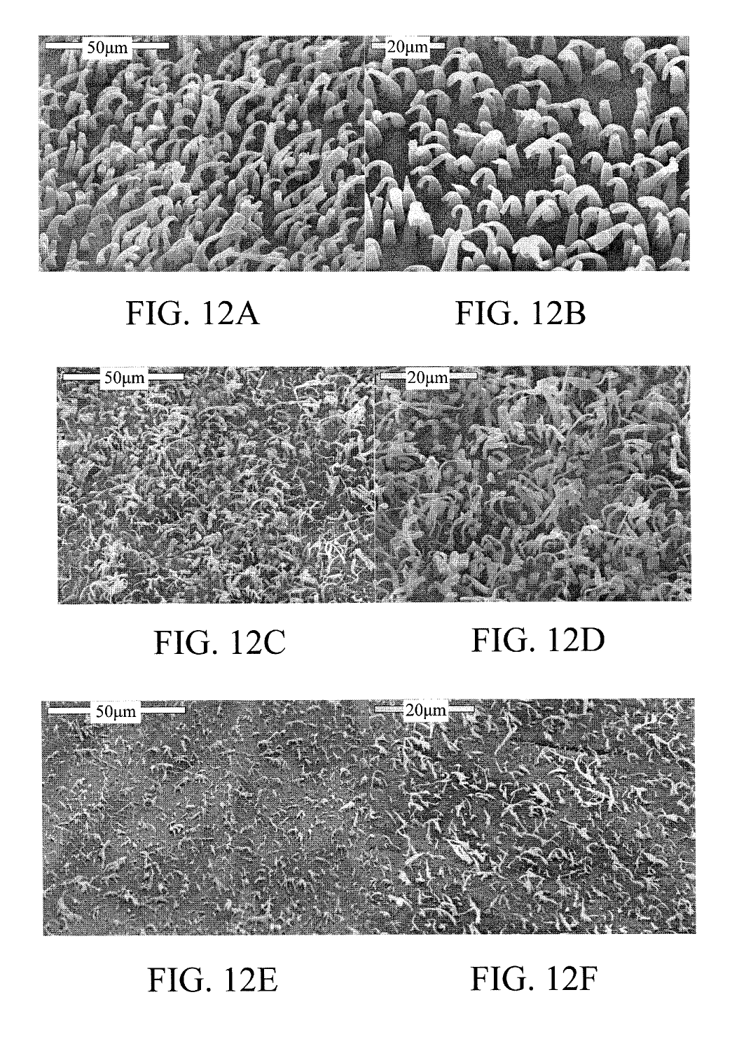

The PP was also molded with polycarbonate (PC) membranes (φ=0.6, 1.2 and 3.0 μm). The molded PP article was separated from the membrane mold by dissolving the membrane in dichloromethane to yield the surface structures shown in FIGS. 11A-11F. For 3.0 and 1.2 μm molded surfaces, cylindrical posts protruded from the bulk article with an average height of about 20 μm with a disordered pore distribution on PC membrane where posts are not perpendicular to the surface as shown in FIG. 11B. Surface molded from the 0.6 μm membrane display height variations and some aggregation of fibers.

The PC membrane was also delaminated from the PP article by peeling the membrane from the article by hand. The morphology of the resulting article's surface depends on the pore size of the PC membrane as shown in FIGS. 12A-12F. The fibers from 3.0 μm membranes are stretched with the tips aligned in the direction of membrane peeling. The fibers molded from 1.2 μm membranes are disordered with some fibers significantly elongated and randomly curled to fiber lengths of over 50 μm. Surfaces cast from delaminated 0.6 μm membranes differ dramatically from the surfaces formed after dissolving of the membrane mold, displaying a density of fibers almost two order of magnitude lower than the membrane's pore density of ˜4×10⁷ cm⁻². The surfaces delaminated from the 0.6 μm membrane, in addition to having a low packing density, show curled fibers of various randomly oriented lengths.

### Low-Density Polyethylene (LDPE) Plastron Surfaces

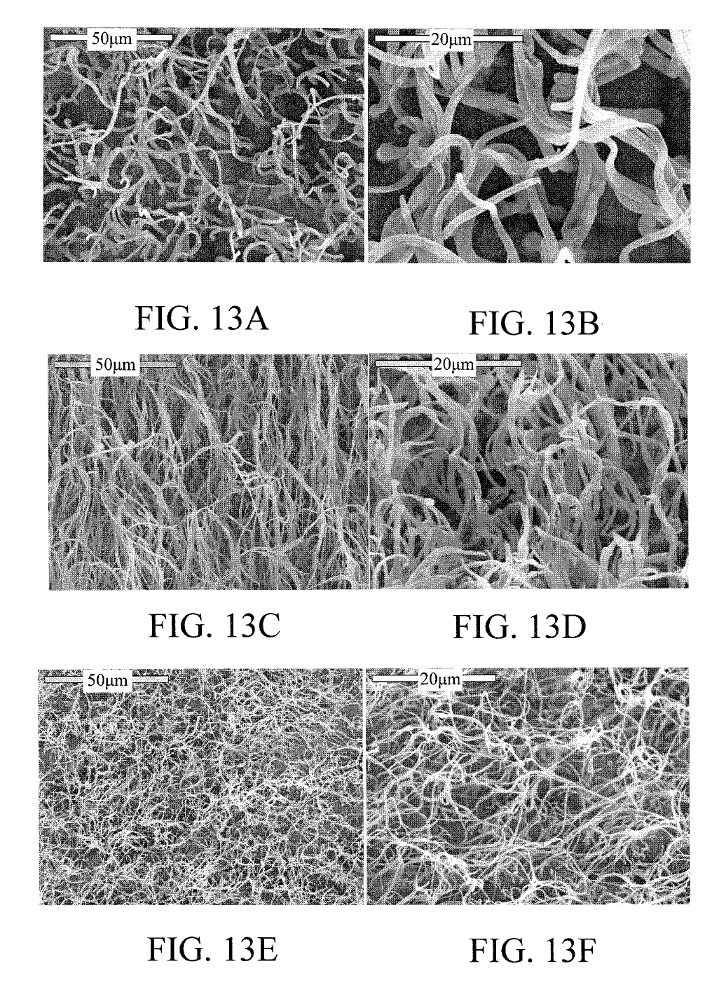

LDPE surfaces were molded using PC membrane pressed together at 140° C. for 6 to 8 minutes followed by removing the membrane by delamination. Sheets of surface molded LDPE are opaque, rather than translucent as before molding. The SEM image, as shown in FIGS. 13A-13F, displays elongated fibers of several hundred micrometers all over the surface that are randomly oriented and entangled with the fiber length dependent on the diameter of the pores of the membrane used as the mold.

### Polyvinylidene Fluoride (PVDF) Plastron Surfaces

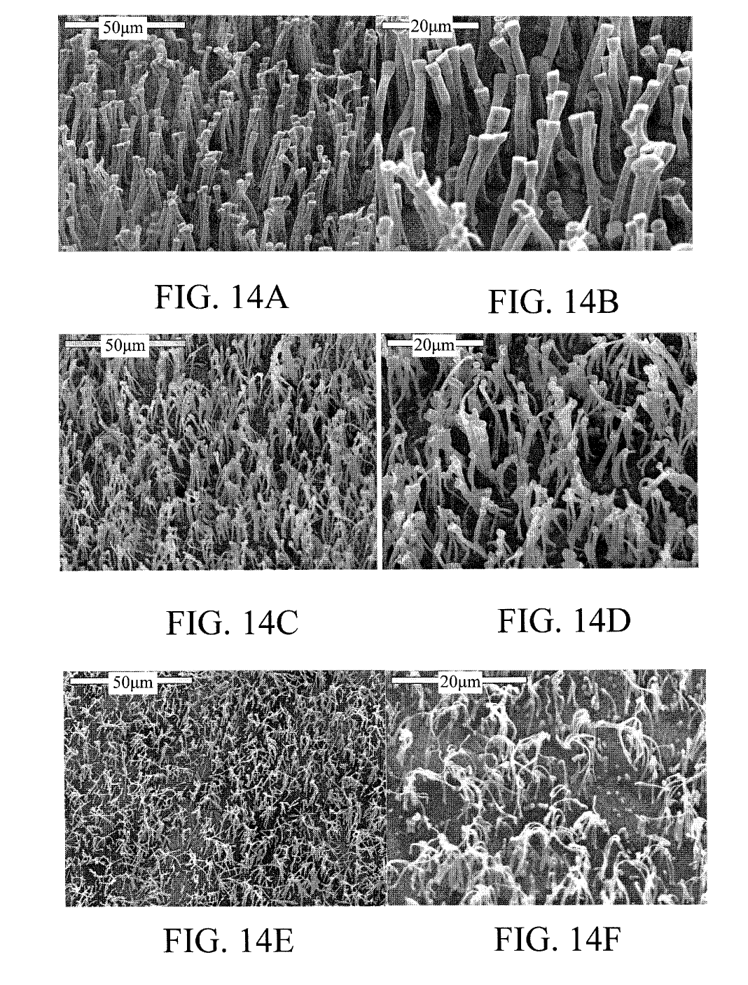

PVDF is a fluoropolymer having a melting point of about 168° C. PVDF was molded at 190° C. using PC membrane molds separated by hand delamination. The surface features from molded PVDF are shown in FIG. 14. Delamination from 3.0 μm membranes was difficult, as the article strongly adhered to the mold, and the images in FIG. 9 were from a very small portion of the article that did delaminate from the membrane near the edge of the PVDF sheet. The distal end of the fiber was larger than the remaining fiber. The surfaces formed upon delamination of the 1.2 μm membrane mold displayed an enlarged end and a greater degree of curling than that from the larger pore membrane. The surface delaminated from the 0.6 μm membrane showed elongated fibers that curled randomly with some fibers apparently sheared from the surface during delamination.

All publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. An insect trap, comprising an area having a multiplicity of rigid pillar and/or hook features extending from a base, where the density of the features is sufficient to inhibit the trajectory of an insect through or over the features.

2. The trap of claim 1, wherein the features are of a thickness of about the thickness of the insect's legs or less and wherein the features are of a height of at least the height of the insect.

3. The trap of claim 2, wherein the features have a height of about 1.5 to about 5 mm, with a diameter of about 0.1 to about 0.4 mm, and are disposed at a density of the features of about 25 to 100 per cm², whereby the traps are effective for adult bedbugs.

4. The trap of claim 2, wherein the features have a height of about 1.5 to about 5 mm, with a diameter of about 0.1 to about 0.4 mm, and are disposed at a density of the features of about 600 per cm², whereby the traps are effective for bedbug nymphs.

5. The trap of claim 1, wherein the features are of a height of at least the circumference of the insect's leg.

6. The trap of claim 4, wherein the features have a height of about 200 to about 500 μm in length and a cross-section about 10 to about 50 μm.

7. The trap of claim 1, further comprising a holding chamber at the base of the trap, wherein the area having a multiplicity of rigid pillar and/or hook features extends from a base, wherein at least a portion of the surface with the features of the area is vertical or inverted, wherein the cross-section of the features is less than 4 μm, wherein the surface is a plastron surface, and wherein the average density of the features is sufficient to exclude the insect's foot-tip from being inserted between features.

8. The trap of claim 1, wherein the features comprise a plurality of densities disposed in a gradient or multiple areas of different densities in any random, periodic or quasiperiodic manner.

9. The trap of claim 1, wherein the microfibers and/or nanofibers are a ceramic, thermoset polymer, or thermoplastic.

10. The trap of claim 9, wherein the thermoplastic is a polypropylene, polyethylene, poly(ethylene terephthalate), poly(butylene terephthalate), Poly(vinylidene fluoride), Polystyrene, or Poly(methylmethacrylate).

11. An insect barrier, comprising an area having a multiplicity of rigid pillar and/or hook features extends from a base, wherein at least a portion of the surface with the features of the area is vertical or inverted, wherein the cross-section of the features is less than 4 μm, wherein the surface is a plastron surface, and wherein the average density of the features is sufficient to exclude the insect's foot-tip from being inserted between features.

12. The insect barrier of claim 11, wherein the base is an attachable sheet or fixed portion of a leg or support of a piece of furniture.
